(19) United States
(12) Patent Application Publication
(10) Pub. No.: US 2025/0184472 A1
(43) Pub. Date: Jun. 5, 2025

(54) CHART, METHOD FOR ADJUSTING IMAGING OPTICAL SYSTEM, METHOD FOR EVALUATING IMAGING OPTICAL SYSTEM, AND EVALUATION APPARATUS

(71) Applicant: Evident Corporation, Nagano (JP)

(72) Inventors: Kazuhiro HAYASHI, Nagano (JP); Motohiro SHIBATA, Nagano (JP)

(73) Assignee: Evident Corporation, Nagano (JP)

(21) Appl. No.: 18/959,872

(22) Filed: Nov. 26, 2024

(30) Foreign Application Priority Data
Dec. 4, 2023 (JP) 2023-204747

(51) Int. Cl. H04N 17/00; G02B 21/36; G06T 7/80

(52) U.S. Cl. CPC H04N 17/002; G02B 21/365; G06T 7/80; G06T 2207/10056

(57) ABSTRACT

A chart has a chart pattern for evaluation of an imaging optical system. The chart pattern includes a plurality of closed regions having the same shape including two orthogonal sides in a contour thereof. Each of the plurality of closed regions includes a bright portion having a circular shape and a dark portion surrounding the bright portion. The plurality of closed regions includes a central closed region arranged at a center of the chart pattern and a plurality of peripheral closed regions arranged radially from the center on concentric circles about the center.

### CROSS REFERENCE TO RELATED APPLICATIONS

This application is based upon and claims the benefit of priority from prior Japanese Patent Application No. 2023-204747, filed Dec. 4, 2023, the entire contents of which are incorporated herein by this reference.

### BACKGROUND OF THE INVENTION

### Field of the Invention

The disclosure of the present specification relates to a chart, a method for adjusting an imaging optical system, a method for evaluating an imaging optical system, and an evaluation apparatus.

### Description of the Related Art

An imaging optical system used in an optical apparatus such as a microscope or a camera includes a plurality of lenses, and the plurality of lenses exhibits sufficient performance when arranged as designed. For this reason, in a process for assembling an imaging optical system, whether the imaging optical system exhibits expected performance is evaluated, and if the performance is not sufficiently exhibited, it is determined that lenses constituting the imaging optical system are not arranged as designed, and an operation for adjusting eccentricity of the lenses and lens intervals is performed.

As one of methods for evaluating an imaging optical system in an assembly process, a method using a flat plate (hereinafter referred to as a chart) on which a predetermined pattern is formed is known. In this method, an imaging optical system to be evaluated is evaluated on the basis of an image of a chart formed through the imaging optical system.

A chart used to evaluate an imaging optical system is described in, for example, JP 2002-350285 A. JP 2002-350285 A describes a technique for calculating a modulation transfer function (MTF) from an image of an edge portion of a pattern using a chart.

Note that, as a representative method for evaluating an imaging optical system using a chart, for example, a method using a shape of a pinhole image is known in addition to a method using an image contrast as described in JP 2002-350285 A.

### SUMMARY OF THE INVENTION

A chart according to an aspect of the present invention is a chart having a chart pattern for evaluation of an imaging optical system, in which the chart pattern includes a plurality of closed regions having a same shape including two orthogonal sides in a contour thereof, each of the plurality of closed regions includes a bright portion having a circular shape and a dark portion surrounding the bright portion, and the plurality of closed regions includes a central closed region arranged at a center of the chart pattern and a plurality of peripheral closed regions arranged radially from the center on concentric circles about the center.

A method for adjusting an imaging optical system according to an aspect of the present invention includes the steps of arranging the chart according to the above aspect such that a bright portion of a closed region provided at a center of the chart pattern of the chart is positioned on an optical axis of the imaging optical system, capturing an image of the chart with an imaging element via the imaging optical system and obtaining a captured image of the chart, generating a plurality of enlarged images obtained by enlarging parts of the captured image corresponding to the plurality of closed regions included in the chart pattern and displaying the enlarged images corresponding to different closed regions in a plurality of display areas arranged in two dimensions, and adjusting eccentricity of the imaging optical system, inclination of an image plane formed by the imaging optical system, and flatness of the image plane on a basis of information displayed in the plurality of display areas.

A method for adjusting an imaging optical system according to another aspect of the present invention includes the steps of arranging the chart according to the above aspect such that a bright portion of a closed region provided at a center of the chart pattern of the chart is positioned on an optical axis of the imaging optical system, capturing an image of the chart with an imaging element via the imaging optical system and obtaining a captured image of the chart, displaying images of a plurality of closed regions included in the chart pattern in the captured image, calculating a result of evaluation of the imaging optical system in each of the plurality of closed regions on a basis of the captured image, displaying, near each image of the plurality of display areas, the result of evaluation in the corresponding closed region, and adjusting eccentricity of the imaging optical system, inclination of an image plane formed by the imaging optical system, and flatness of the image plane on a basis of the displayed result of evaluation.

A method for evaluating an imaging optical system according to an aspect of the present invention includes the steps of arranging the chart according to the above aspect such that a bright portion of a closed region provided at a center of the chart pattern of the chart is positioned on an optical axis of the imaging optical system, capturing an image of the chart with an imaging element via the imaging optical system and obtaining a captured image of the chart, generating a plurality of enlarged images obtained by enlarging parts of the captured image corresponding to the plurality of closed regions included in the chart pattern and displaying the enlarged images corresponding to different closed regions in a plurality of display areas arranged in two dimensions, and determining necessity of adjustment of eccentricity of the imaging optical system, inclination of an image plane formed by the imaging optical system, and flatness of the image plane on a basis of information displayed in the plurality of display areas.

A method for evaluating an imaging optical system according to another aspect of the present invention includes the steps of arranging the chart according to the above aspect such that a bright portion of a closed region provided at a center of the chart pattern of the chart is positioned on an optical axis of the imaging optical system, capturing an image of the chart with an imaging element via the imaging optical system and obtaining the captured image of the chart, displaying images of a plurality of closed regions included in the chart pattern in the captured image, calculating a result of evaluation of the imaging optical system in each of the plurality of closed regions on a basis of the captured image, displaying, near each image of the plurality of display areas, the result of evaluation in the corresponding closed region, and determining necessity of adjustment of eccentricity of the imaging optical system, inclination of an image plane formed by the imaging optical system, and flatness of the image plane on a basis of the displayed result of evaluation.

An evaluation apparatus according to an aspect of the present invention includes a microscope including an imaging optical system, an imaging element that captures an image of the chart according to claim 1 via the imaging optical system, and a processor, in which the processor calculates a result of evaluation of the imaging optical system in each of the plurality of closed regions included in the chart pattern of the chart on a basis of a captured image, which is an image of the chart captured by the imaging element, and the processor determines necessity of adjustment of the imaging optical system on a basis of a plurality of results of evaluation of the imaging optical system corresponding to the plurality of closed regions.

### BRIEF DESCRIPTION OF THE DRAWINGS

The present invention will be more apparent from the following detailed description when the accompanying drawings are referenced.

FIG. 1 is a diagram illustrating a microscope system according to an embodiment of the present invention;

FIG. 2 is a diagram illustrating an example of a chart according to the embodiment of the present invention;

FIG. 3 is an enlarged view of a closed region included in the chart illustrated in FIG. 1;

FIG. 4 illustrates an example of an image obtained by imaging the closed region illustrated in FIG. 3 via an imaging optical system;

FIG. 5 is a diagram illustrating an operation for adjusting the imaging optical system;

FIG. 6 is a flowchart illustrating an example of a procedure of a method for adjusting an imaging optical system according to a first embodiment;

FIG. 7 illustrates an example of a screen displayed in the method for adjusting an imaging optical system according to the first embodiment;

FIG. 8 is an enlarged view of contrast information illustrated in FIG. 7;

FIG. 9 illustrates an example of a screen displayed in a method for adjusting an imaging optical system according to a second embodiment;

FIG. 10 illustrates an example of a screen displayed in a method for adjusting an imaging optical system according to a third embodiment;

FIG. 11 illustrates an example of a screen displayed in a method for adjusting an imaging optical system according to a fourth embodiment;

FIG. 12 is a flowchart illustrating an example of a procedure of a method for evaluating an imaging optical system according to a fifth embodiment;

FIG. 13 illustrates an example of a screen displayed in the method for evaluating an imaging optical system according to the fifth embodiment; and

FIG. 14 illustrates an example of a screen displayed in a method for evaluating an imaging optical system according to a sixth embodiment.

### DESCRIPTION OF THE EMBODIMENTS

In evaluation of an imaging optical system by the two evaluation methods described above, dedicated charts are usually used. In order to comprehensively evaluate an imaging optical system by both of these evaluation methods, therefore, it is necessary to switch charts.

Charts used for the evaluation, however, are required to have accuracy equal to or higher than performance of an imaging optical system to be evaluated. When such charts requiring high accuracy are switched, an error between the charts makes it difficult to correctly evaluate an imaging optical system even if each of the charts is manufactured with sufficiently high accuracy.

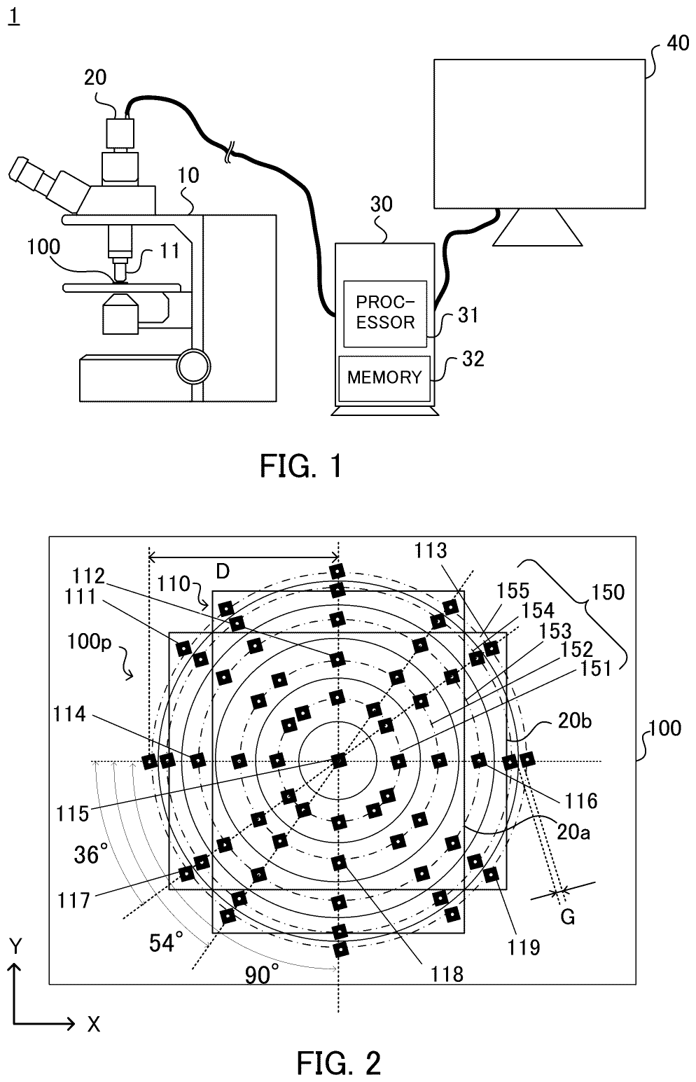

Embodiments of the present invention will be described hereinafter. FIG. 1 is a diagram illustrating a microscope system according to an embodiment of the present invention. A microscope system 1 illustrated in FIG. 1 is a system used to evaluate an imaging optical system using a chart 100, and includes a microscope 10, an imaging device 20, a computer 30, and a display 40.

The microscope 10 includes an imaging optical system to be evaluated. The imaging device 20 is attached to a lens barrel of the microscope 10. The imaging optical system projects an image of the chart 100 arranged on a stage of the microscope 10 onto the imaging device 20. The imaging device 20 includes an imaging element, and obtains an image (hereinafter referred to as a captured image) of the chart 100 by imaging the chart 100 via the imaging optical system of the microscope 10. The chart 100 has a chart pattern for evaluation of the imaging optical system. Performance of the imaging optical system between the chart 100 and the imaging device 20, therefore, is appropriately reflected in the captured image.

The microscope 10 may be an upright microscope or an inverted microscope. Furthermore, in the microscope 10, transmitted illumination may be employed, or epi-illumination may be employed. A case where the microscope 10 is an upright microscope that projects the image of the chart 100 onto the imaging device 20 using transmitted illumination will be described hereinafter as an example.

The computer 30 is, for example, a personal computer including a processor 31 and a memory 32. On the basis of a fact that performance of an imaging optical system is reflected in a captured image, the computer 30 processes a captured image obtained by the imaging device 20 to generate information contributing to evaluation of the imaging optical system. The computer 30 also causes the display 40 to display the generated information contributing to the evaluation of the imaging optical system. The processor 31 performs this process by executing a program stored in the memory 32.

A user of the microscope system 1 checks the information displayed on the display 40 to evaluate the imaging optical system, and determines whether or not the imaging optical system has been appropriately assembled so as to exhibit the performance as designed. If the user determines that the imaging optical system has not been appropriately assembled, the user performs an adjustment operation on the imaging optical system.

The imaging optical system includes an objective lens 11 and other lenses (an imaging lens, an adapter lens, etc.). When the other lenses are sufficiently adjusted in advance, the objective lens 11 can be essentially evaluated by evaluating the imaging optical system.

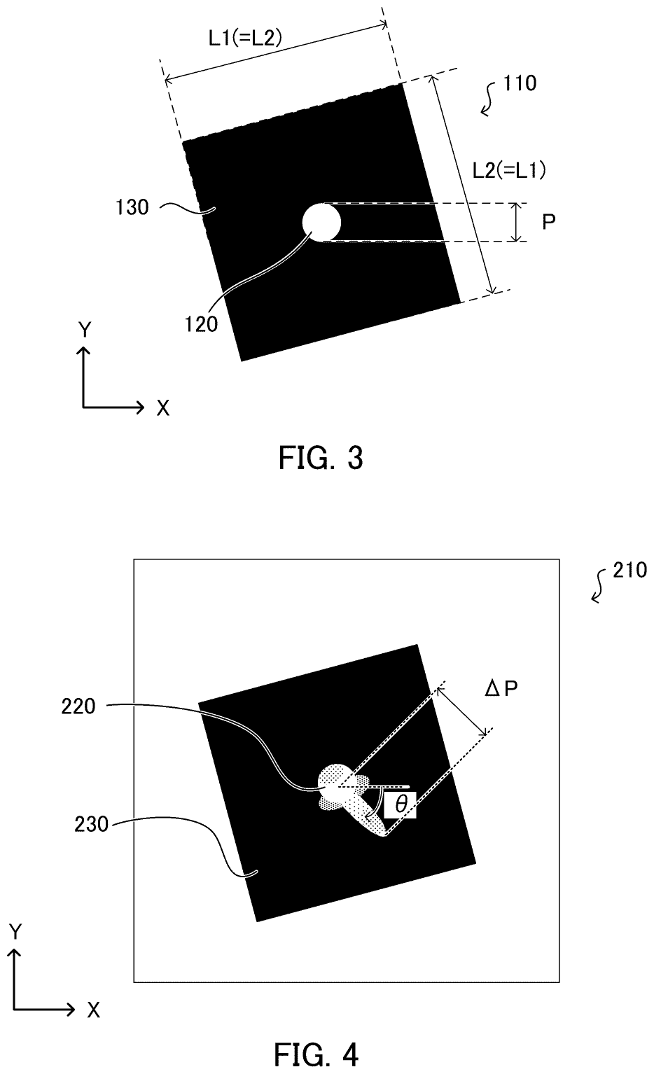

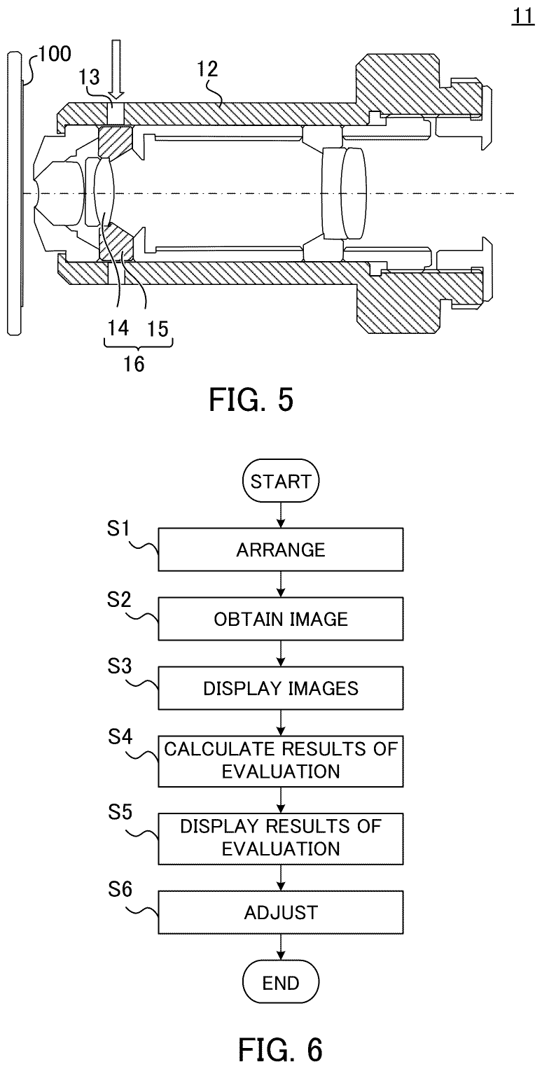

FIG. 2 is a diagram illustrating an example of a chart according to the embodiment of the present invention. FIG. 3 is an enlarged view of a closed region included in the chart illustrated in FIG. 1. FIG. 4 illustrates an example of an image obtained by imaging the closed region illustrated in FIG. 3 via an imaging optical system. FIG. 5 is a diagram illustrating an operation for adjusting the imaging optical system. The chart 100 used in the microscope system 1 will be described hereinafter with reference to FIGS. 2 to 5.

The chart 100 includes a chart pattern 100p for evaluation of the imaging optical system that enables comprehensive evaluation of the imaging optical system from both contrast and shapes of images. Specifically, as illustrated in FIG. 2, the chart pattern 100p includes a plurality of closed regions 110.

As illustrated in FIGS. 2 and 3, each of the plurality of closed regions 110 has the same shape including two orthogonal sides in a contour thereof. The shape of the closed region 110 is a square in this example, but may be any shape as long as the shape includes two orthogonal sides, and may be a rectangle or a fan shape including two orthogonal sides.

The two orthogonal sides constituting the contour are suitable for evaluating contrast of an image 210 of a closed region 110 (an image 230 of a peripheral region 130 described later) illustrated in FIG. 4. In order to evaluate contrast of an image, for example, a line spread function (LSF) may be calculated by differentiating a density profile of a portion (line) across two sides of the image 230 illustrated in FIG. 4, and a modulation transfer function (MTF) may be calculated by Fourier transforming the LSF through processing performed by the computer 30. In addition, as a method for evaluating contrast of an image, a value (Brenner gradient) obtained by squaring a difference between luminance values of pixels adjacent in X and Y directions and integrating the squared difference may be used as an evaluation value.

Note that, as illustrated in FIGS. 2 and 3, it is desirable that the two orthogonal sides of the closed region 110 be inclined with respect to the X and Y direction in which pixels of a captured image are aligned. This is because it is possible to virtually calculate a combined LSF with a finer sampling pitch by differentiating concentration profiles of a plurality of lines across inclined sides (edges) and combining a plurality of obtained LSFs. Note that inclination of the edges is not particularly limited, but is, for example, about 1.5° to 3°.

As illustrated in FIG. 3, each of the plurality of closed regions 110 includes a pinhole 120 and a peripheral region 130 surrounding the pinhole 120. The pinhole 120 is an example of a bright portion having a circular shape. The pinhole 120 may be, for example, an opening (through hole) provided in the chart 100, or may be a transmission member that transmits illumination light. The peripheral region 130 is an example of a dark portion surrounding the bright portion, and includes the above-described two orthogonal sides. The peripheral region 130 may be, for example, a light shielding member provided on a surface of the chart 100. Note that the light shielding member is formed of a thin film of metal. Thickness of the light shielding member is, for example, 0.1 μm or less, and does not have a substantial thickness.

The pinhole 120, which is the bright portion surrounded by the peripheral region 130, which is the dark portion, is suitable for evaluating a shape of an image (pinhole image 220). In order to evaluate the shape of the image (pinhole image 220), for example, a direction (angle θ in FIG. 4) in which a blurred tail of the pinhole image (pinhole image 220) is drawn, a tail length (ΔP in FIG. 4), and the like may be calculated through processing performed by the computer 30. As described above, each of the closed regions 110 in which the pinhole 120 is provided in the dark portion (peripheral region 130) including orthogonal edges (two sides) is suitable for both evaluation of contrast of an image and evaluation of a shape of a pinhole image. By using the chart 100, therefore, the imaging optical system can be comprehensively evaluated from both contrast and shapes of images. In addition, since the chart pattern 100p includes the plurality of closed regions 110, it is possible to individually evaluate the imaging optical system at each of positions corresponding to closed regions 110 in a field of view without moving the chart 100 with respect to the imaging optical system.

Moreover, as illustrated in FIG. 2, the plurality of closed regions 110 includes a closed region 110 (referred to as a central closed region) arranged at a center 101 of the chart pattern 100p, and a plurality of closed regions 110 (referred to as peripheral closed regions) arranged radially from the center 101 on concentric circles 150 about the center 101. That is, the chart pattern 100p includes the plurality of closed regions 110 (peripheral closed regions) on each of circles constituting the concentric circles 150 (a concentric circle 151, a concentric circle 152, a concentric circle 153, a concentric circle 154, and a concentric circle 155) centered on the center 101, and each of the plurality of closed regions 110 (peripheral closed regions) on each circle is arranged in the same orientation from the center 101 as corresponding closed regions 110 (peripheral closed regions) on the other circles. As described above, since the plurality of closed regions 110 is aligned in a radial direction and a circumferential direction around the center 101, it is possible to grasp how evaluation changes with respect to each of the radial direction and the circumferential direction by comparing results of evaluation at positions corresponding to the closed regions 110.

By using the chart 100 having the chart pattern 100p, it is possible to comprehensively evaluate whether the imaging optical system exhibits expected performance from both contrast and shape of an image at each of positions (more precisely, positions corresponding to the closed regions 110) in the field of view. Since replacement of the chart 100 is not necessary for the evaluation, it is possible to avoid adverse effects on the evaluation due to differences in error between charts 100. In addition, since it is not necessary to move the chart 100 to evaluate at different positions in the field of view, it is possible to avoid an effect of errors in the position or inclination caused by the movement. Furthermore, by comparing results of the evaluation at positions in the field of view, it is also possible to grasp deviation in the performance of the imaging optical system.

The user may perform necessary adjustment on the imaging optical system (objective lens 11) on the basis of these pieces of information. As illustrated in FIG. 5, for example, a lens unit 16 may be projected from a hole 13 provided in a barrel member 12 of the objective lens 11 with an adjustment rod to adjust eccentricity of a lens 14 fixed to a lens frame 15. In addition, the objective lens 11 may be reassembled to adjust lens intervals. As a result, the imaging optical system can be adjusted to exhibit the performance as designed.

Furthermore, in order to accurately evaluate the periphery of the optical system, it is desirable to define oblique directions of the chart pattern 100p and a radius D of the outermost concentric circle 155 included in the concentric circles 150 such that closed regions are imaged around four corners of the field of view (a rectangle obtained by projecting the imaging element on an object plane) of the imaging device used, that is, closed regions are arranged in diagonal directions of the field of view of the imaging device.

For example, when an aspect ratio of the imaging device 20 (imaging element) is 4:3, regardless of whether the imaging device 20 is arranged in a vertical direction or a horizontal direction with respect to the chart pattern 100p, it is desirable to arrange the closed regions 110 such that some closed regions 110 are positioned around the four corners of the chart pattern 100p. As a result, the field of view of the imaging device 20 can be accurately evaluated regardless of whether the imaging device 20 is arranged in the vertical direction or the horizontal direction.

Specifically, as illustrated in FIG. 2, it is desirable to arrange the closed regions 110 in four oblique directions (±36° directions and ±54° directions) in addition to the vertical direction and the horizontal direction. Rectangles 20a and 20b in FIG. 2 indicate ranges of the field of view of the imaging device when the imaging device is arranged in the vertical direction and the horizontal direction, respectively. The chart 100 is configured such that closed regions 110 are arranged at four corners of both the rectangles 20a and 20b.

Note that, when the aspect ratio of the imaging device 20 (imaging element) is 1:1, the closed regions 110 may be arranged in two oblique directions (±45° directions) in addition to the vertical direction and the horizontal direction.

Next, a more desirable configuration of the chart pattern 100p will be described. First, a desirable configuration of the closed regions 110 included in the chart pattern 100p will be described, and then a desirable configuration of intervals between the closed regions 110 will be described.

As illustrated in FIG. 3, a pinhole 120 in each closed region 110 is desirably located near a center of gravity of the closed region 110. For example, a position of the center of gravity of each closed region 110 is desirably located in the pinhole 120. Diameter of the pinhole 120 is preferably ⅕ or less of short sides of the closed region 110. That is, when the diameter of the pinhole 120 is denoted by P and length of a short side of two orthogonal sides included in the contour of the closed region 110 is denoted by L1, the chart 100 desirably satisfies the following Conditional Expression (1).

$$P \leq L 1 / 5 \qquad ( 1 )$$

Since the pinhole 120 is near the center of gravity of the closed region 110 and Conditional Expression (1) is satisfied, the imaging optical system can be more appropriately evaluated from both contrast and shape of an image using the chart 100.

The pinhole 120 is surrounded by the peripheral region 130, but when the adjustment of the imaging optical system is insufficient, for example, a shape of the image 220 of the pinhole 120 is deformed as illustrated in FIG. 4. At this time, in order to correctly recognize the shape of the image 220 of the pinhole 120, it is desirable that the image 220 of the pinhole 120 is contained in the image 230 of the peripheral region 130, which is the dark portion. This is because, if the image 220 protrudes from the image 230, it becomes difficult to correctly grasp the shape of the image 220 of the pinhole, so that sensitivity to insufficient adjustment (for example, misalignment or the like) of the imaging optical system decreases.

When the pinhole 120 is at a position greatly deviated from the center of gravity of the closed region 110, the image 220 of the pinhole 120 easily protrudes from the image 230 of the peripheral region 130, which is not desirable. In addition, even when the pinhole 120 is near the center of gravity of the closed region 110, if the pinhole 120 is too large with respect to the closed region 110, the image 220 of the pinhole 120 easily protrudes from the image 230 of the peripheral region 130, which is not desirable. In order to appropriately evaluate the shape of the image 220 of the pinhole 120, therefore, it is desirable that the pinhole 120 is near the center of gravity of the peripheral region 130 and Conditional Expression (1) is satisfied.

In addition, if the image 220 of the pinhole 120 protrudes from the image 230 of the peripheral region 130, evaluation of contrast of the edges of the peripheral region 130 might be adversely affected. In order to appropriately evaluate contrast of the image 230 of the peripheral region 130, therefore, it is desirable that the pinhole 120 is near the center of gravity of the peripheral region 130 and Conditional Expression (1) is satisfied.

Conditional Expression (1) is a condition that the pinhole 120 is not too large with respect to the peripheral region 130, but it is also not desirable that the pinhole 120 is too small with respect to the peripheral region 130.

The pinhole 120 desirably has such a size that the shape of the image 220 of the pinhole 120 enlarged through the imaging optical system can be visually recognized. That is, it is desirable that a user observing the image 220 of the pinhole 120 can recognize how much the shape is deformed from the circular shape. In addition, the diameter of the pinhole 120 is desirably larger than at least resolution (Rayleigh resolution, Abbe resolution, Hopkins resolution, etc.) of the imaging optical system. Specifically, when wavelength of light used for evaluation of the imaging optical system is denoted by 2 and a numerical aperture of the imaging optical system on an object side is denoted by NA, the chart 100 desirably satisfies the following Conditional Expression (2). Note that, when a human performs evaluation through visual observation, visible light (400 nm to 700 nm) is used, and the wavelength 2 is, for example, 550 nm with a high luminous efficiency function.

$$P \geq 1.5 \times λ / NA \qquad ( 2 )$$

Since the image 220 of the pinhole 120 can be visually recognized and Conditional Expression (2) is satisfied, the imaging optical system can be more appropriately evaluated from the shape of the pinhole image using the chart 100.

For example, when an objective lens of NA=0.70 is evaluated, the closed region 110 of the chart 100 may be configured in the following size as an example.
Pinhole diameter P=2 μm
Length L of two sides=30 μm (=L1=L2)

The closed region 110 is desirably smaller than 1/10 of a maximum image height evaluated using the chart pattern 100p. Furthermore, it is desirable that there is a gap wide enough to contain at least another closed region 110 between closed regions 110 adjacent to each other in an image height direction (radial direction). That is, when length of a long side of two orthogonal sides included in the contour of the closed region 110 is denoted by L2, a radius of the outermost concentric circle 155 included in the concentric circles 150 is denoted by D, and a minimum gap between radially adjacent closed regions 110 on the concentric circles 150 is denoted by G, the chart 100 desirably satisfies the following Conditional Expressions (3) and (4).

$$L 2 \leq D / 10 \qquad ( 3 )$$

$$G \geq L 2 \qquad ( 4 )$$

The imaging optical system is often evaluated at intervals of an image height ratio of 0.1. When the size of the closed region 110 is larger than 1/10 of the maximum image height, closed regions 110 arranged at positions corresponding to image heights at intervals of 0.1 might overlap each other. In order to correctly perform evaluation at each image height, therefore, it is desirable to satisfy Conditional Expression (3).

In addition, when the closed region 110 itself is too large, it is difficult to regard the four corners of the closed region 110 as points of the same image height. In particular, when a gap between radially adjacent closed regions 110 is small and the gap is smaller than the length of the closed region 110 (for example, diagonal length or L2), it is difficult to say that it is appropriate to treat the evaluation of the imaging optical system in each closed region 110 as the evaluation at a specific image height. It is therefore desirable to simultaneously satisfy Conditional Expressions (3) and (4).

In each embodiment, a specific example of a method for adjusting an imaging optical system and a method for evaluating an imaging optical system using the chart 100 described above will be described.

### First Embodiment

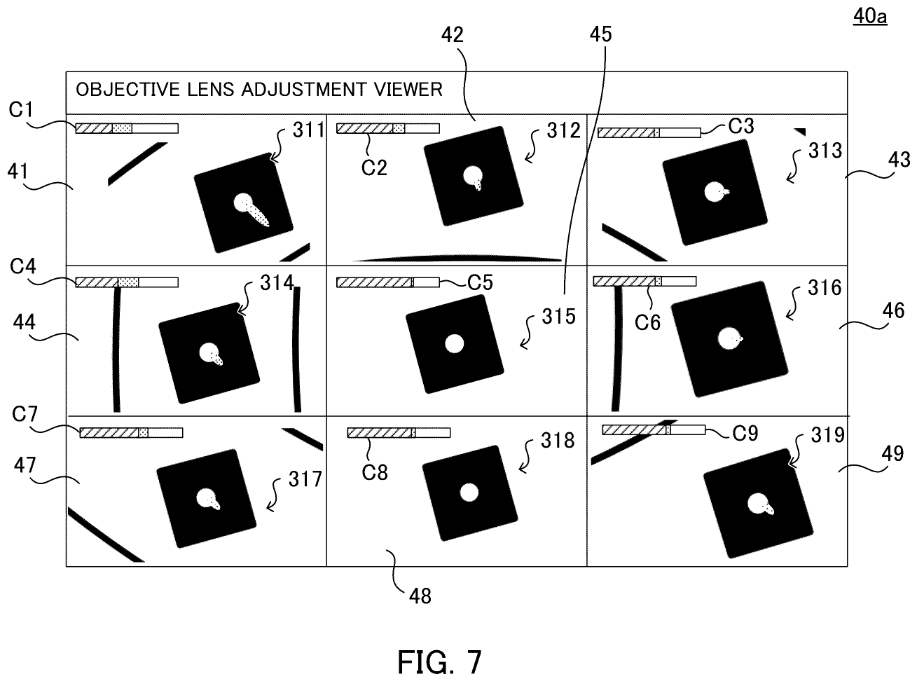

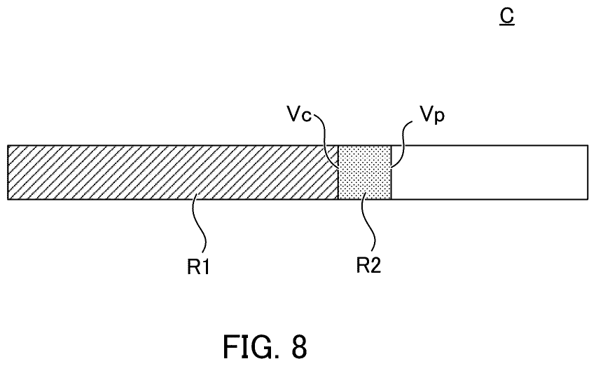

FIG. 6 is a flowchart illustrating an example of a procedure of the method for adjusting an imaging optical system according to the present embodiment. FIG. 7 illustrates an example of a screen displayed in the method for adjusting an imaging optical system according to the present embodiment. FIG. 8 is an enlarged view of contrast information illustrated in FIG. 7.

In the method for adjusting an imaging optical system according to the present embodiment, first, the chart 100 is arranged on the stage of the microscope system 1 as illustrated in FIG. 6 (step S1). Here, the chart 100 is arranged such that the pinhole 120 of the closed region 110 provided at the center 101 of the chart pattern 100p is positioned on an optical axis of the imaging optical system. For example, this arrangement may be manually performed by the user of the microscope system 1, or may be automatically performed by an electric component of the microscope system 1.

Next, the microscope system 1 captures an image of the chart 100 with the imaging device 20 via the imaging optical system to obtain the captured image of the chart 100 (step S2). Thereafter, the microscope system 1 displays images of closed regions 110 on the display 40 on the basis of the captured image obtained in step S2 (step S3).

In step S3, first, the microscope system 1 generates a plurality of enlarged images (enlarged images 311 to 319) obtained by enlarging parts of the captured image corresponding to a plurality of closed regions 110 included in the chart pattern 100p. The plurality of enlarged images may be generated by selecting two or more closed regions 110 from all the closed regions 110 included in the chart pattern 100p. Note that each of the enlarged images is generated, for example, by cutting out and enlarging a part of the captured image corresponding to a closed region 110.

Thereafter, as illustrated in FIG. 7, the microscope system 1 displays the plurality of enlarged images (the enlarged images 311 to 319) on a screen 40a of the display 40. More specifically, the microscope system 1 displays enlarged images corresponding to different closed regions in a plurality of display areas (display areas 41 to 49) arranged on the screen 40a of the display 40 in two dimensions. The enlarged images may be displayed on the display 40 at a display magnification higher than a magnification when the entire captured image is displayed on the display 40.

Which enlarged image is displayed in which display area is determined on the basis of a positional relationship between the display areas and the closed areas. That is, step S3 includes a process for determining an enlarged image to be displayed in each of the plurality of display areas on the basis of the positional relationship between the display areas and the closed regions.

Specifically, the microscope system 1 may display an enlarged image 315 corresponding to the central closed region provided at the center 101 of the chart pattern 100p (or an enlarged image corresponding to a peripheral closed region close to the central closed region) in a central display area 45 among nine display areas illustrated in FIG. 7. In addition, the microscope system 1 may display enlarged images corresponding to peripheral closed regions in upward, downward, leftward, and rightward directions from the center 101 in display areas in upward, downward, leftward, and rightward directions from the center, respectively, among the remaining eight display areas illustrated in FIG. 7. Enlarged images corresponding to peripheral closed regions located in upper-left, lower-left, upper-right, and lower-right directions from the center 101 may be displayed in display areas located in upper-left, lower-left, upper-right, and lower-right directions from the center, respectively. The enlarged images 311 to 319 displayed in the display areas 41 to 49 illustrated in FIG. 7 include closed regions 111 to 119, respectively, illustrated in FIG. 2.

When step S3 ends, the microscope system 1 calculates a result of evaluation of the imaging optical system in each of the plurality of closed regions corresponding to the plurality of display areas on the basis of the captured image obtained in step S2 (step S4). The results of evaluation calculated in step S4 are, for example, information (hereinafter simply referred to as contrast information) indicating contrast of the enlarged images of the closed regions.

After calculating the results of evaluation, the microscope system 1 displays the results of evaluation calculated in step S4 on the screen 40a of the display 40 (step S5). Specifically, as illustrated in FIG. 7, the microscope system 1 displays the contrast information (contrast information C1 to C9), which is the results of evaluation in the corresponding closed regions, in the plurality of display areas on the basis of the results of evaluation calculated in step S4.

Contrast information C (a generic term for the contrast information C1 to C9) is, for example, a band graph in which a level of contrast can be intuitively grasped as illustrated in FIG. 8. In this band graph, for example, a region R1 from 0 to a current value Vc of contrast and a region R2 from the current value Vc to a peak value Vp are displayed in different colors. Note that the peak value Vp is a peak value of contrast in the corresponding closed region. When the imaging optical system is evaluated while performing focusing, for example, the peak value Vp can be regarded as a contrast value in a most focused state.

Order of execution of steps S3 to S5 described above is not particularly limited. As illustrated in FIG. 7, the enlarged image of and the result of evaluation in the closed region may be displayed in a corresponding one of the plurality of display areas.

After the enlarged images and the results of evaluation are displayed, the imaging optical system is adjusted on the basis of the information (the enlarged images and the contrast information) displayed in the plurality of display areas (step S6). More specifically, the user of the microscope system 1 adjusts the eccentricity of the lenses of the imaging optical system and the lens intervals to adjust the eccentricity of the imaging optical system, inclination of an image plane formed by the imaging optical system, and flatness of the image plane.

With the method for adjusting an imaging optical system using the chart 100 illustrated in FIG. 6 described above, the user can evaluate shapes of pinhole images from enlarged images displayed on the display 40 and also evaluate contrast of the images from contrast information displayed on the display 40. The imaging optical system, therefore, can be comprehensively evaluated from the shapes and contrast of the images, and necessary adjustment can be performed on the imaging optical system.

In addition, enlarged images of and results of evaluation in a plurality of closed regions are displayed in corresponding display areas obtained by dividing the screen 40a. Since the enlarged images of the closed regions and the results of evaluation displayed in the display areas are determined on the basis of a positional relationship between the display areas and the closed regions, the user can grasp at a glance how performance of the imaging optical system changes in the field of view on the basis of the information displayed in the display areas.

### Second Embodiment

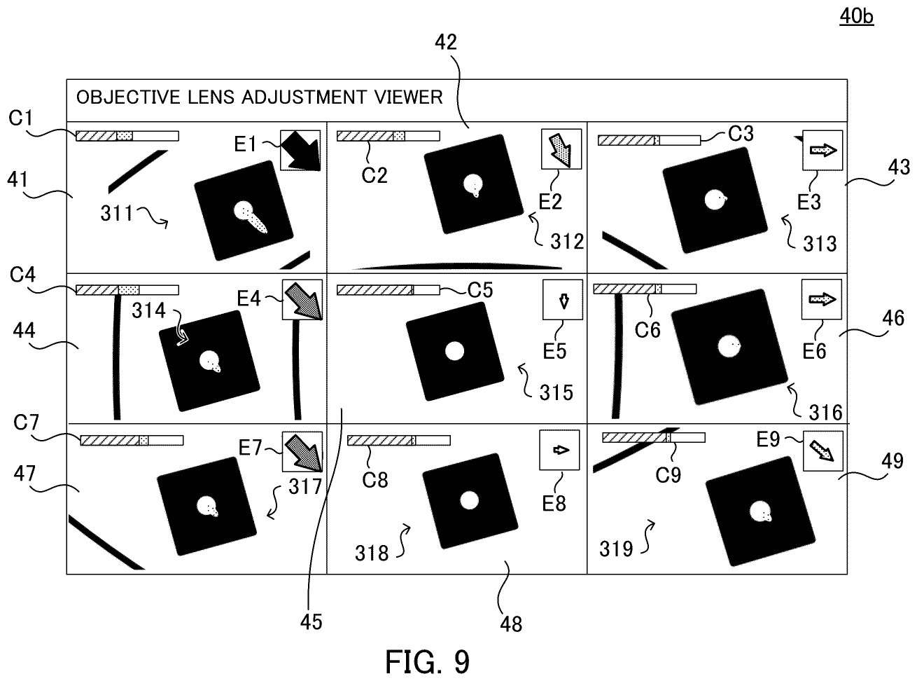

FIG. 9 illustrates an example of a screen displayed in a method for adjusting an imaging optical system according to the present embodiment. A procedure of the method for adjusting an imaging optical system using the chart 100 according to the present embodiment is the same as that according to the first embodiment except that results of evaluation calculated in step S4 and displayed in step S5 are different.

In the present embodiment, in step S4, the microscope system 1 calculates, as results of evaluation, shape information indicating shapes of pinhole images in addition to contrast information regarding enlarged images of closed regions corresponding to the results of evaluation. The shape information indicating the shape of each pinhole image includes, for example, a direction in which a tail of the pinhole image extends (for example, an angle θ in FIG. 4) and length of the tail of the pinhole image (for example, the length ΔP in FIG. 4).

After the results of evaluation are calculated in step S4, the microscope system 1 displays, in step S5, a screen 40b illustrated in FIG. 9 on the display 40 on the basis of the results of evaluation calculated in step S4. The screen 40b is different from the screen 40a in the first embodiment in that contrast information (contrast information C1 to C9) and shape information (shape information E1 to E9), which are results of evaluation in closed regions, are displayed in corresponding display areas.

Note that shape information E (a generic term for the shape information E1 to E9) may be any information as long as a degree of degradation of a shape of a pinhole image can be intuitively grasped, and is, for example, an arrow figure as illustrated in FIG. 9. In this case, size (thickness and length) and color density of an arrow may indicate length of a tail, and a direction of the arrow may indicate a direction of the tail.

By the method for adjusting an imaging optical system according to the present embodiment, too, the user can comprehensively evaluate the imaging optical system from shapes and contrast of images and perform necessary adjustment as in the first embodiment. In particular, in the present embodiment, shapes of pinhole images can be evaluated from the shape information (the shape information E1 to E9) in addition to the enlarged images (the enlarged images 311 to 319) displayed on the display 40.

### Third Embodiment

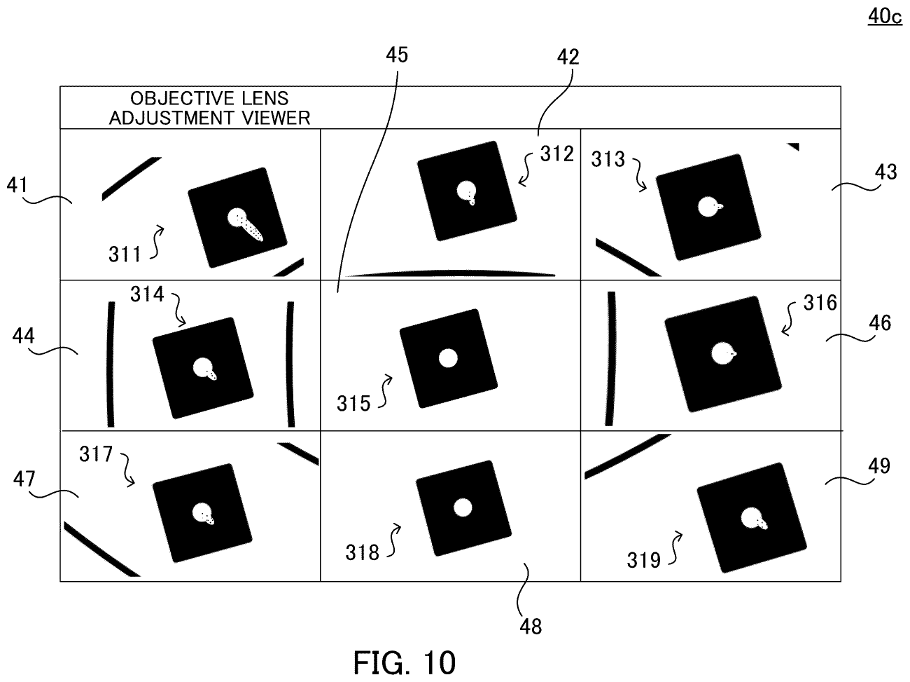

FIG. 10 illustrates an example of a screen displayed in a method for adjusting an imaging optical system according to the present embodiment. A procedure of the method for adjusting an imaging optical system using the chart 100 according to the present embodiment is the same as that according to the first embodiment except that the step of calculating results of evaluation in step S4 and the step of displaying the results of evaluation in step S5 are omitted.

In the present embodiment, the microscope system 1 displays a screen 40c illustrated in FIG. 10 on the display 40. The user evaluates both shapes of pinhole images and contrast of the images from enlarged images displayed on the display 40. Therefore, by the adjustment method according to the present embodiment, too, it is possible to comprehensively evaluate the imaging optical system from shapes and contrast of images and perform necessary adjustment.

### Fourth Embodiment

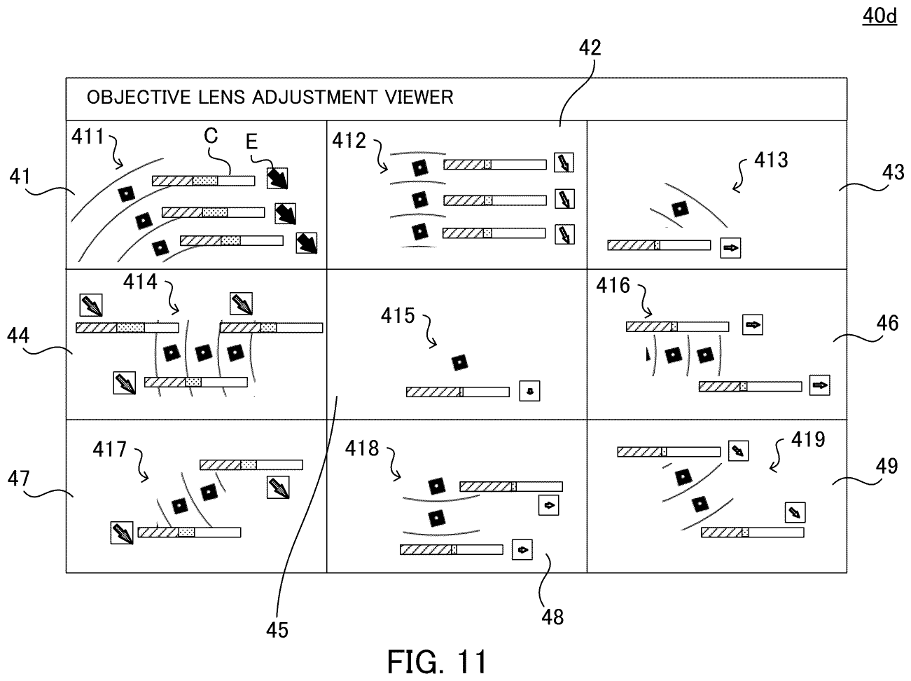

FIG. 11 illustrates an example of a screen displayed in a method for adjusting an imaging optical system according to the present embodiment. A procedure of the method for adjusting an imaging optical system using the chart 100 according to the present embodiment is the same as that according to the second embodiment except that images themselves (images 411 to 419) cut out from a captured image instead of enlarged images are displayed in step S3 and that a result of evaluation (contrast information C) is displayed not for each display area but for each image displayed in the display areas in step S5.

In the present embodiment, in step S3, the microscope system 1 displays images of a plurality of closed regions included in the chart pattern 100p in the captured image. The plurality of images may be generated by selecting two or more closed regions 110 from all the closed regions 110 included in the chart pattern 100p. Note that each of the images is generated, for example, by cutting out a part of the captured image corresponding to a closed region 110.

In the present embodiment, in step S3, the microscope system 1 displays images of a plurality of closed regions included in the chart pattern 100p in the captured image. Specifically, the microscope system 1 first selects two or more closed regions 110 from all the closed regions 110 included in the chart pattern 100p and cuts out parts of the captured image corresponding to the selected closed regions 110 to generate a plurality of images. Thereafter, as illustrated in FIG. 11, the microscope system 1 displays different images (the images 411 to 419) in the plurality of display areas (the display areas 41 to 49) arranged on the screen 40d of the display 40 in two dimensions. Each image only needs to include one or more closed region portions, and may include a plurality of closed region portions.

When step S3 ends, the microscope system 1 calculates contrast information C and shape information E as a result of evaluation of the imaging optical system in each of the plurality of closed regions displayed in the plurality of display areas on the basis of the captured image obtained in step S2 (step S4). Note that the shape information E is an example of first evaluation information indicating a direction in which a bright portion included in an image of a corresponding closed region extends and length of the bright portion included in the image, and the contrast information C is an example of second evaluation information indicating contrast of an image of a corresponding closed region.

After calculating the results of evaluation in step S4, the microscope system 1 displays the results of evaluation calculated in step S4 on the screen 40d of the display 40 (step S5). Specifically, as illustrated in FIG. 11, the microscope system 1 displays the results of evaluation (the contrast information C and the shape information E) in the corresponding closed regions near the images of the plurality of closed regions. That is, when images of a plurality of closed regions are included in an image as in the image 411, the result of evaluation in each closed region is displayed near the image of the closed region.

By the method for adjusting an imaging optical system according to the present embodiment, too, the user can comprehensively evaluate the imaging optical system from shapes and contrast of images and perform necessary adjustment as in the above embodiments. In addition, in the present embodiment, by displaying images cut out from a captured image, it is possible to display images of more closed regions than when enlarged images are displayed, and therefore it is possible to check performance in a wider range in the field of view. In addition, it is difficult to grasp shapes of pinhole images from the images when enlarged images are not used as compared with when enlarged images are displayed, but by displaying the shape information E in addition to the images, the shapes of the pinhole images can be appropriately evaluated as when enlarged images are displayed.

Although an example in which the user determines the necessity of adjustment of the imaging optical system while viewing a screen displayed on the display 40 has been described in the first to fourth embodiments, the microscope system 1 may determine the necessity of adjustment of the imaging optical system and display a result of the determination on the display 40, instead. An example in which the microscope system 1 operates as an evaluation apparatus that determines the necessity of adjustment of the imaging optical system and that displays a result of the determination will be described hereinafter.

### Fifth Embodiment

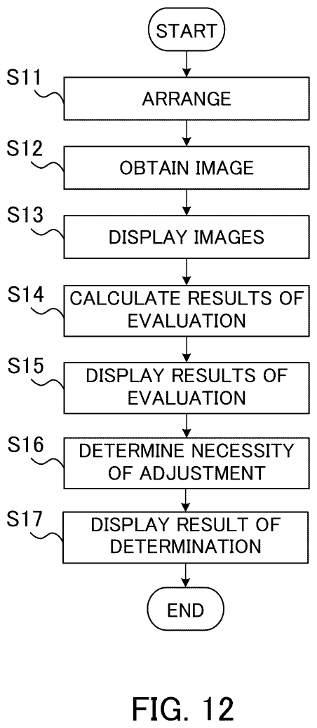

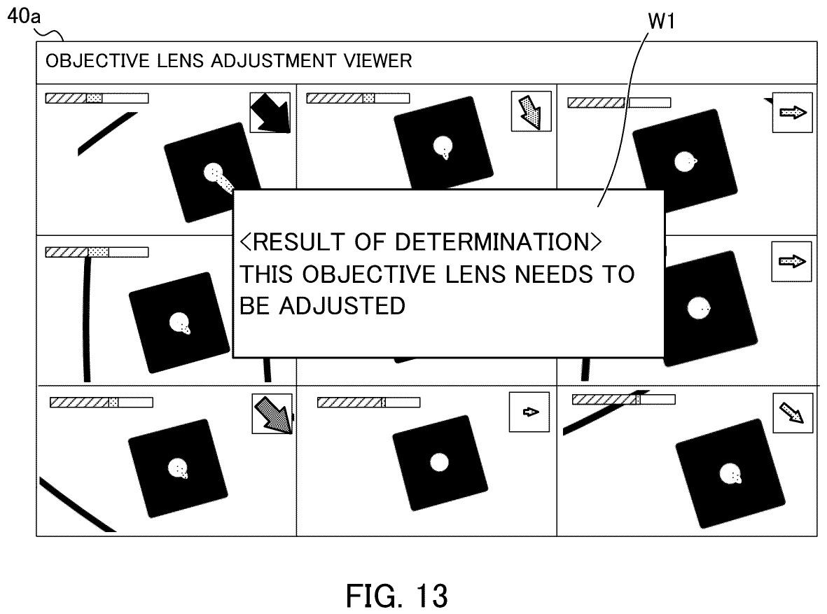

FIG. 12 is a flowchart illustrating an example of a procedure of a method for evaluating an imaging optical system according to the present embodiment. FIG. 13 illustrates an example of a screen displayed in the method for adjusting an imaging optical system according to the present embodiment.

In the method for evaluating an imaging optical system according to the present embodiment, first, the chart 100 is arranged on the stage of the microscope system 1 as illustrated in FIG. 12 (step S11). Thereafter, the microscope system 1 obtains a captured image of the chart 100 (step S12), and displays, on the basis of the captured image, enlarged images corresponding to different closed regions in a plurality of display areas arranged on the screen 40a of the display 40 in two dimensions (step S13). Furthermore, the microscope system 1 calculates a result of evaluation of the imaging optical system in each of the plurality of closed regions corresponding to the plurality of display areas on the basis of the captured image obtained in step S2 (step S14), and displays, in each of the plurality of display areas, a result of evaluation in the corresponding closed region on the basis of the result of evaluation calculated in step S4 (step S15). Note that the processing in steps S11 to S15 is similar to the processing in steps S1 to S5 of the method for adjusting an imaging optical system according to the second embodiment.

Thereafter, the microscope system 1 determines the necessity of adjustment of the imaging optical system (step S16). Here, the microscope system 1 determines the necessity of adjustment of the eccentricity of the imaging optical system, the necessity of adjustment of the inclination of the image plane formed by the imaging optical system, and the necessity of adjustment of the flatness of the image plane on the basis of the information displayed in the plurality of display areas. A determination method is not particularly limited, but for example, the eccentricity of the imaging optical system may be determined on the basis of whether a result of evaluation (contrast information C and shape information E) in each closed region falls within an expected allowable range of performance, and the inclination and flatness of the image plane of the imaging optical system may be determined on the basis of presence or absence of bias of results of evaluation in closed regions in the field of view.

Finally, the microscope system 1 displays a result of the determination as to the necessity of adjustment of the imaging optical system (step S17). A method of displaying a result of a determination is not particularly limited, but the microscope system 1 may pop-up display a new window W1 including the result of the determination on the screen 40a of the display 40, for example, as illustrated in FIG. 13. Note that the user who has checked the result of the determination may then adjust the imaging optical system.

With the method for evaluating an imaging optical system according to the present embodiment, the microscope system 1 can comprehensively evaluate the imaging optical system from shapes and contrast of images and determine the necessity of adjustment of the imaging optical system. In addition, the microscope system 1 evaluates the imaging optical system in accordance with a certain standard, so that adjustment work can be performed on the basis of the necessity of adjustment of the imaging optical system determined in accordance with the certain standard regardless of the user of the microscope system 1. Furthermore, since the microscope system 1 displays an enlarged image of and a result of evaluation in each closed region on the screen 40a, the user himself/herself can check whether the determination made by the microscope system 1 is appropriate on the basis of the enlarged image and the result of evaluation. Since the determination made by the microscope system 1 does not become a black box, therefore, the user can adjust the imaging optical system as necessary with satisfaction of the determination.

### Sixth Embodiment

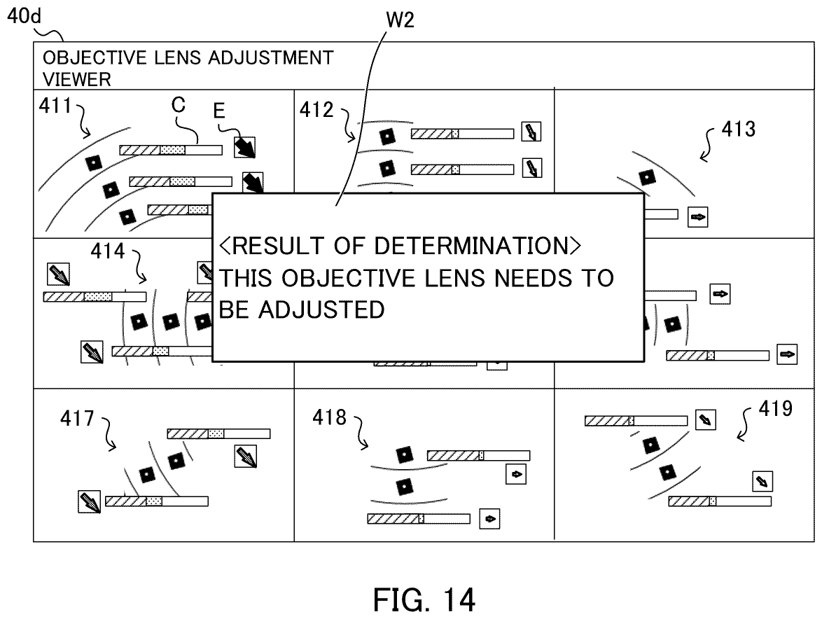

FIG. 14 illustrates an example of a screen displayed in a method for evaluating an imaging optical system according to the present embodiment. Processing in steps S11 to S15 in a procedure of the method for evaluating an imaging optical system using the chart 100 according to the present embodiment is similar to the processing in steps S1 to S5 in the method for adjusting an imaging optical system according to the fourth embodiment.

Thereafter, the microscope system 1 determines the necessity of adjustment of the imaging optical system (step S16), and displays a result of the determination as to the necessity of adjustment of the imaging optical system (step S17). A method of displaying a result of a determination is not particularly limited, but the microscope system 1 may pop-up display a new window W2 including the result of the determination on the screen 40d of the display 40, for example, as illustrated in FIG. 14. Note that the user who has checked the result of the determination may then adjust the imaging optical system.

By the method for evaluating an imaging optical system according to the present embodiment, too, the microscope system 1 can comprehensively evaluate the imaging optical system from shapes and contrast of images and determine the necessity of adjustment of the imaging optical system as with the evaluation method according to the fifth embodiment. In addition, the microscope system 1 evaluates the imaging optical system in accordance with a certain standard, so that the user can perform adjustment work on the basis of the necessity of adjustment of the imaging optical system determined in accordance with the certain standard, and the user himself/herself can check whether the determination made by the microscope system 1 is appropriate on the basis of images and results of evaluation as in the fifth embodiment.

The above-described embodiments are specific examples to facilitate an understanding of the invention, and hence the present invention is not limited to such embodiments. Modifications obtained by modifying the above-described embodiments and alternatives to the above-described embodiments may also be included. In other words, the components of each embodiment can be modified without departing from the spirit and scope of the embodiment. In addition, new embodiments can be implemented by appropriately combining a plurality of components disclosed in one or more of the embodiments. Furthermore, some components may be omitted from the constituent elements in each of the embodiments, or some constituent elements may be added to the constituent elements in each of the embodiments. Moreover, the order of the processing described in each of the embodiments may be changed as long as there is no contradiction.

Although the chart 100 including one pinhole 120 in each closed region 110 has been described as an example in the above-described embodiments, the chart for evaluating the imaging optical system may include a plurality of pinholes 120 in each closed region 110, instead. In this case, too, although the pinholes 120 satisfy Conditional Expression (1), a more severe condition such as P≤L1/10 may be imposed on the diameter P of the pinholes 120 in accordance with the number of pinholes 120 included in each closed region 110.

Sizes of the plurality of pinholes 120 included in each closed region 110 may be the same or different. When the sizes of the plurality of pinholes 120 are different from each other, the pinhole diameter may be set in accordance with specifications of the imaging optical system such as NA and magnification.

Note that when a plurality of pinholes 120 is included in each closed region 110, a bright portion corresponding to the pinhole 120 might not be located at a position of the center of gravity of the closed region 110.

Although the chart 100 has the pinholes 120 that transmit light as circular bright portions in the above-described embodiments, the bright portions are not limited to the pinholes 120. In a microscope system employing epi-illumination, a chart may have a configuration in which light is reflected as circular bright portions or a configuration in which light is transmitted through dark portions surrounding the bright portions.

Although an example in which a plurality of closed regions 110 is arranged radially has been described in the above-described embodiments, the closed regions 110 need not necessarily be arranged radially as long as the closed regions 110 are arranged in a plurality of orientations from the center 101. The radial arrangement, however, is desirable in that the imaging optical system can be evaluated from results of evaluation of the plurality of closed regions 110 arranged on different concentric circles for each orientation.

Although an example in which the same number of closed regions 110 is arranged on each concentric circle, the same number of closed regions 110 need not necessarily be arranged as long as a plurality of closed regions 110 is arranged on each concentric circle.

Although not particularly mentioned in the above-described embodiments, the imaging optical system is desirably evaluated in a state where the chart 100 is focused. The steps of the methods illustrated in FIGS. 6 and 12 after the obtaining of an image may be performed for each of z positions at a time of focus adjustment, instead. That is, at the time of focus adjustment, the obtaining of an image, the calculation of evaluation, and the display of images and results of evaluation may be repeatedly performed in real time. In this case, the contrast information C displayed in each display area may be used to determine whether the focus has been correctly adjusted.

Although an example in which a plurality of display areas has the same size has been described in the above-described embodiments, a plurality of display areas may include display areas of different sizes, instead. For example, in the example illustrated in FIG. 11, the display area 45, in which a range of an image to be displayed is relatively narrow, may be configured to be smaller than the surrounding display areas. As a result, a space in the screen 40d can be used more efficiently.

In the present specification, an expression “on the basis of A” does not indicate “on the basis of only A” but indicates “on the basis of at least A” and further indicates “partially on the basis of at least A”. That is, “on the basis of A” may indicate “on the basis of B in addition to A” or “on the basis of a part of A”

What is claimed is:

1. A chart having a chart pattern for evaluation of an imaging optical system, wherein
the chart pattern includes a plurality of closed regions having a same shape including two orthogonal sides in a contour thereof,
each of the plurality of closed regions includes:
a bright portion having a circular shape; and
a dark portion surrounding the bright portion, and
the plurality of closed regions includes:
a central closed region arranged at a center of the chart pattern; and
a plurality of peripheral closed regions arranged radially from the center on concentric circles about the center.

2. The chart according to claim 1, wherein
a position of a center of gravity of each of the plurality of closed regions is located in the bright portion, and
a following conditional expression
$$P \leq L 1 / 5 \qquad ( 1 )$$
is satisfied,
where L1 denotes length of a short side of the two sides included in the contour of the closed region and P denotes diameter of the bright portion.

3. The chart according to claim 2, wherein
a following conditional expression
$$P \geq 1.5 \times λ / NA \qquad ( 2 )$$
is satisfied,
where, λ denotes a wavelength of light used for evaluation of the imaging optical system and NA denotes a numerical aperture of the imaging optical system on an object side.

4. The chart according to claim 1, wherein
following conditional expressions
$$L 2 \leq D / 10 \qquad ( 3 )$$
$$G \geq L 2 \qquad ( 4 )$$
are satisfied,
where L2 denotes length of a long side of the two sides included in the contour of the closed region, D denotes a radius of an outermost circle of the concentric circles, and G denotes a smallest gap between the radially adjacent closed regions on the concentric circles.

5. The chart according to claim 2, wherein
following conditional expressions
$$L 2 \leq D / 10 \qquad ( 3 )$$
$$G \geq L 2 \qquad ( 4 )$$
are satisfied,
where L2 denotes length of a long side of the two sides included in the contour of the closed region, D denotes a radius of an outermost circle of the concentric circles, and G denotes a smallest gap between the radially adjacent closed regions on the concentric circles.

6. A method for adjusting an imaging optical system, the method comprising the steps of:
arranging the chart according to claim 1 such that a bright portion of a closed region provided at a center of the chart pattern of the chart is positioned on an optical axis of the imaging optical system;
capturing an image of the chart with an imaging element via the imaging optical system and obtaining a captured image of the chart;
generating a plurality of enlarged images obtained by enlarging parts of the captured image corresponding to the plurality of closed regions included in the chart pattern and displaying the enlarged images corresponding to different closed regions in a plurality of display areas arranged in two dimensions; and
adjusting eccentricity of the imaging optical system, inclination of an image plane formed by the imaging optical system, and flatness of the image plane on a basis of information displayed in the plurality of display areas.

7. The method according to claim 6, further comprising the steps of:
calculating, on a basis of the captured image, a result of evaluation of the imaging optical system in each of the plurality of closed regions corresponding to the plurality of display areas; and
displaying, in each of the plurality of display areas, the result of evaluation in the corresponding closed region.

8. The method according to claim 6, wherein
the step of displaying the enlarged images includes a step of determining an enlarged image to be displayed in each of the plurality of display areas on a basis of a positional relationship between the display area and the corresponding closed area.

9. A method for adjusting an imaging optical system, the method comprising the steps of:
arranging the chart according to claim 1 such that a bright portion of a closed region provided at a center of the chart pattern of the chart is positioned on an optical axis of the imaging optical system;
capturing an image of the chart with an imaging element via the imaging optical system and obtaining a captured image of the chart;
displaying images of a plurality of closed regions included in the chart pattern in the captured image;
calculating a result of evaluation of the imaging optical system in each of the plurality of closed regions on a basis of the captured image;
displaying, near each image of the plurality of closed regions, the result of evaluation in the corresponding closed region; and
adjusting eccentricity of the imaging optical system, inclination of an image plane formed by the imaging optical system, and flatness of the image plane on a basis of the displayed result of evaluation.

10. The method according to claim 9, wherein
the result of evaluation includes:
first evaluation information indicating a direction in which the bright portion included in the image of the corresponding closed region extends and length of the bright portion included in the image; and
second evaluation information indicating contrast of the image of the corresponding closed region.

11. The method according to claim 9, wherein
the step of displaying the images of the plurality of closed regions includes a step of determining positions where the images of the plurality of closed regions are to be displayed on a basis of a positional relationship between the plurality of closed regions.

12. A method for evaluating an imaging optical system, the method comprising the steps of:
arranging the chart according to claim 1 such that a bright portion of a closed region provided at a center of the chart pattern of the chart is positioned on an optical axis of the imaging optical system;
capturing an image of the chart with an imaging element via the imaging optical system and obtaining a captured image of the chart;
generating a plurality of enlarged images obtained by enlarging parts of the captured image corresponding to the plurality of closed regions included in the chart pattern and displaying the enlarged images corresponding to different closed regions in a plurality of display areas arranged in two dimensions; and
determining necessity of adjustment of eccentricity of the imaging optical system, necessity of adjustment of inclination of an image plane formed by the imaging optical system, and necessity of adjustment of flatness of the image plane on a basis of information displayed in the plurality of display areas.

13. The method according to claim 12, further comprising the steps of:
calculating, on a basis of the captured image, a result of evaluation of the imaging optical system in each of the plurality of closed regions corresponding to the plurality of display areas; and
displaying, in each of the plurality of display areas, the result of evaluation in the corresponding closed region.

14. The method according to claim 12, wherein
the step of displaying the enlarged images includes a step of determining an enlarged image to be displayed in each of the plurality of display areas on a basis of a positional relationship between the display area and the corresponding closed area.

15. A method for evaluating an imaging optical system, the method comprising the steps of:
arranging the chart according to claim 1 such that a bright portion of a closed region provided at a center of the chart pattern of the chart is positioned on an optical axis of the imaging optical system;
capturing an image of the chart with an imaging element via the imaging optical system and obtaining a captured image of the chart;
displaying images of a plurality of closed regions included in the chart pattern in the captured image;
calculating a result of evaluation of the imaging optical system in each of the plurality of closed regions on a basis of the captured image;
displaying, near each image of the plurality of closed regions, the result of evaluation in the corresponding closed region; and
determining necessity of adjustment of eccentricity of the imaging optical system, necessity of adjustment of inclination of an image plane formed by the imaging optical system, and necessity of adjustment of flatness of the image plane on a basis of the displayed result of evaluation.

16. The method according to claim 15, wherein
the result of evaluation includes:
first evaluation information indicating a direction in which the bright portion included in the image of the corresponding closed region extends and length of the bright portion included in the image; and
second evaluation information indicating contrast of the image of the corresponding closed region.

17. The method according to claim 15, wherein
the step of displaying the images of the plurality of closed regions includes a step of determining positions where the images of the plurality of closed regions are to be displayed on a basis of a positional relationship between the plurality of closed regions.

18. An evaluation apparatus comprising:
a microscope including an imaging optical system;
an imaging element that captures an image of the chart according to claim 1 via the imaging optical system; and
a processor, wherein
the processor
calculates a result of evaluation of the imaging optical system in each of the plurality of closed regions included in the chart pattern of the chart on a basis of a captured image, which is an image of the chart captured by the imaging element, and
determines necessity of adjustment of the imaging optical system on a basis of a plurality of results of evaluation of the imaging optical system corresponding to the plurality of closed regions.

19. The evaluation apparatus according to claim 18, wherein
the result of evaluation includes:
first evaluation information indicating a direction in which the bright portion included in the image of the corresponding closed region extends and length of the bright portion included in the image; and
second evaluation information indicating contrast of the image of the corresponding closed region.
